(19) United States
(12) Patent Application Publication
(10) Pub. No.: US 2018/0322404 A1
(43) Pub. Date: Nov. 8, 2018

(54) Time Series Based Data Prediction Method and Apparatus

(71) Applicant: Alibaba Group Holding Limited, Grand Cayman (KY)

(72) Inventors: Yu Wang, Hangzhou (CN); Zhou Ye, Hangzhou (CN); Jineng Wang, Hangzhou (CN); Yang Yang, Hangzhou (CN); Fan Chen, Hangzhou (CN); Qian Qian, Hangzhou (CN); Zhaoping Dong, Hangzhou (CN)

(21) Appl. No.: 16/034,281

(22) Filed: Jul. 12, 2018

Related U.S. Application Data
(63) Continuation of application No. PCT/CN2017/070356, filed on Jan. 6, 2017.

(30) Foreign Application Priority Data
Jan. 14, 2016 (CN) 201610024102.6

(51) Int. Cl. G06N 5/04; G06Q 30/02

(52) U.S. Cl. CPC G06N 5/04; G06Q 30/0202

(57) ABSTRACT

A method and an apparatus for data prediction based on time series are provided. The method includes obtaining historical time series data of a plurality of category objects, the category objects including one or more data objects; selecting feature category object(s) from the plurality of category objects, the feature category object(s) being category object(s) including a respective feature data object, and the respective feature data object being a data object having a life cycle less than a predetermined time threshold; and predicting a target data object from among data object(s) included in the feature category object(s) based on historical time series data corresponding to the feature category object(s), the target data object being a data object with future time series data that is generated in a future first predetermined time period and satisfies a predetermined growth trend.

### CROSS REFERENCE TO RELATED PATENT APPLICATIONS

This application claims priority to and is a continuation of PCT Patent Application No. PCT/CN2017/070356 filed on 6 Jan. 2017, and is related to and claims priority to Chinese Patent Application No. 201610024102.6, filed on 14 Jan. 2016, entitled “Time Series Based Data Prediction Method and Apparatus,” which are hereby incorporated by reference in their entirety.

### TECHNICAL FIELD

The present disclosure relates to the technical field of data processing, and particularly to methods and apparatuses of data prediction based on time series.

### BACKGROUND

Along with the development of information technologies, a distribution of villages has become a very important aspect of strategic distributions of electronic commerce platforms, allowing commodities to go out through the electronic commerce platforms and allowing commodities from outside to enter into the villages. Most commodities of the villages are highly time-sensitive and seasonal commodities, even having very short expiration periods, such as seafood, freshwater fish, and fresh vegetables and fruits, etc. These types of commodities can be called time-sensitive commodities. A time-sensitive commodity is referred to as a commodity having a time-sensitive characteristic of consumption and a very short expiration period.

In reality, although the need for time-sensitive commodities is huge, the challenges to electronic commerce platforms and logistic systems thereof are also tremendous, which are manifested in two aspects:

(1) If too much storage exists, an excessive pressure is placed on the logistics, often leading to great losses due to short expiration periods of types of commodities; and

(2) If a shortage of storage exists due to incorrect estimation, this will result in a huge market loss.

Therefore, identification and prediction of time-sensitive data objects such as time-sensitive commodities are particularly important.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the aforementioned problems, embodiments of the present disclosure are proposed to provide a time series based data prediction method and a corresponding time series based data prediction apparatus for solving the above problems or at least a portion of the above problems.

In order to solve the aforementioned problems, the present disclosure discloses a time series based data prediction method. The method includes obtaining historical time series data of a plurality of category objects, the category objects including one or more data objects; selecting feature category object(s) from the plurality of category objects, the feature category object(s) being category object(s) including a respective feature data object, and the respective feature data object being a data object having a life cycle less than a predetermined time threshold; and predicting a target data object from among data object(s) included in the feature category object(s) based on historical time series data corresponding to the feature category object(s), the target data object being a data object with future time series data that is generated in a future first predetermined time period and satisfies a predetermined growth trend.

In implementations, the method further includes predicting the future time series data of the target data object in the future first predetermined time period.

In implementations, obtaining the historical time series data of the plurality of category objects includes calculating an amount of designated feature data corresponding to the data object that is stored in a predetermined database in each time interval as historical feature data of the data object in the respective time interval, for a plurality of predetermined time intervals; organizing historical feature data of the data object in all the time intervals to obtain historical time series data of the data object; calculating a sum of historical feature data of data objects included in each category object in the respective time interval according to the respective time interval; and organizing respective sums of historical feature data of all the time interval as historical time series data of the respective category object.

In implementations, selecting feature category object(s) from the plurality of category objects includes selecting a first feature category object from the plurality of category objects based on the historical time series data of the plurality of category objects; obtaining a predetermined second feature category object; and organizing the first feature category object and the second feature category object as a feature category object.

In implementations, selecting the first feature category object from the plurality of category objects based on the historical time series data of the plurality of category objects includes calculating a median value M of historical time series data of each category object in a previous first predetermined time period; calculating a number of time intervals in which a sum of historical feature data is greater than a predetermined multiple of M; and determining that the category object is the first feature category object if the number of intervals in which the sum of historical feature data is greater than the predetermined multiple of M is within a predetermined range.

In implementations, predicting the target data object from among the data object(s) included in the feature category object(s) based on the historical time series data corresponding to the feature category object(s) includes normalizing the feature category object(s) based on the historical time series data corresponding to the feature category object(s); clustering the data object(s) included in the normalized feature category object(s) to obtain class cluster object(s); predicting a target class cluster object from the class cluster object(s); and setting a data object included in the target class cluster object as the target data object.

In implementations, predicting the target class cluster object from the class cluster object(s) includes calculating first average historical time series data of the class cluster object(s) based on historical time series data of data objects in the class cluster object(s) in a previous one month; calculating second average historical time series data of the class cluster object(s) based on historical time series data of data objects in the class cluster object(s) in a previous thirteenth month; calculating third average historical time series data of the class cluster object(s) based on historical time series data of data objects in the class cluster object(s) in a previous twelfth month; predicting future average time series data of the class cluster object(s) in the future first predetermined time period based on the first average historical time series data, the second average historical time series data and the third average historical time series data; calculating a difference between the future average time series data and the first average historical time series data to obtain indicator data of the class cluster object(s); and setting a class cluster object having indicator data greater than a predetermined threshold as the target class cluster object.

In implementations, predicting the future time series data of the target data object in the future first predetermined time period includes normalizing future average time series data of the class cluster object(s) in the future first predetermined time period to obtain a standard average time series data of each data object in the class cluster object(s); and correcting the standard average time series data of each data object to obtain future time series data of the respective data object in the future first predetermined time period.

In implementations, the data object is commodity data, the category objects are commodity categories, the feature category object(s) is/are time-sensitive commodity categor(ies), the life cycle is a time limit of a commodity, and the time series data is a daily sales volume of the commodity.

The present disclosure further discloses a time series based data prediction apparatus. The apparatus includes a historical time series data acquisition module used for obtaining historical time series data of a plurality of category objects, the category objects including one or more data objects; a feature category object selection module used for selecting feature category object(s) from the plurality of category objects, the feature category object(s) being category object(s) including a respective feature data object, and the respective feature data object being a data object having a life cycle less than a predetermined time threshold; and a target data object prediction module used for predicting a target data object from among data object(s) included in the feature category object(s) based on historical time series data corresponding to the feature category object(s), the target data object being a data object with future time series data that is generated in a future first predetermined time period and satisfies a predetermined growth trend.

In implementations, the apparatus further includes a future time series data prediction module used for predicting the future time series data of the target data object in the future first predetermined time period.

In implementations, the historical time series data acquisition module includes a historical feature data computation sub-module used for calculating an amount of designated feature data corresponding to the data object that is stored in a predetermined database in each time interval as historical feature data of the data object in the respective time interval, for a plurality of predetermined time intervals; a historical feature data organization sub-module used for organizing historical feature data of the data object in all the time intervals to obtain historical time series data of the data object; a historical feature data statistics sub-module used for calculating a sum of historical feature data of data objects included in each category object in the respective time interval according to the respective time interval; and a historical time series data organization sub-module used for organizing respective sums of historical feature data of all the time interval as historical time series data of the respective category object.

In implementations, the feature category object selection module includes a first feature category object selection sub-module used for selecting a first feature category object from the plurality of category objects based on the historical time series data of the plurality of category objects; a second feature category object acquisition sub-module used for obtaining a predetermined second feature category object; and an organization sub-module used for organizing the first feature category object and the second feature category object as a feature category object.

In implementations, the first feature category object selection sub-module is further used for calculating a median value M of historical time series data of each category object in a previous first predetermined time period; calculating a number of time intervals in which a sum of historical feature data is greater than a predetermined multiple of M; and determining that the category object is the first feature category object if the number of intervals in which the sum of historical feature data is greater than the predetermined multiple of M is within a predetermined range.

In implementations, the target data object prediction module includes a normalization sub-module used for normalizing the feature category object(s) based on the historical time series data corresponding to the feature category object(s); a clustering sub-module used for clustering the data object(s) included in the normalized feature category object(s) to obtain class cluster object(s); a prediction sub-module used for predicting a target class cluster object from the class cluster object(s); and a target data object acquisition sub-module used for setting a data object included in the target class cluster object as the target data object.

In implementations, the prediction sub-module is further used for calculating first average historical time series data of the class cluster object(s) based on historical time series data of data objects in the class cluster object(s) in a previous one month; calculating second average historical time series data of the class cluster object(s) based on historical time series data of data objects in the class cluster object(s) in a previous thirteenth month; calculating third average historical time series data of the class cluster object(s) based on historical time series data of data objects in the class cluster object(s) in a previous twelfth month; predicting future average time series data of the class cluster object(s) in the future first predetermined time period based on the first average historical time series data, the second average historical time series data and the third average historical time series data; calculating a difference between the future average time series data and the first average historical time series data to obtain indicator data of the class cluster object(s); and setting a class cluster object having indicator data greater than a predetermined threshold as the target class cluster object.

In implementations, the future time series data prediction module includes a standard data acquisition sub-module used for normalizing future average time series data of the class cluster object(s) in the future first predetermined time period to obtain a standard average time series data of each data object in the class cluster object(s); and a correction sub-module used for correcting the standard average time series data of each data object to obtain future time series data of the respective data object in the future first predetermined time period.

In implementations, the data object is commodity data, the category objects are commodity categories, the feature category object(s) is/are time-sensitive commodity categor(ies), the life cycle is a time limit of a commodity, and the time series data is a daily sales volume of the commodity.

The embodiments of the present disclosure include the following advantages.

The embodiments of the present disclosure can select time-sensitive and seasonal feature category objects from a plurality of category objects, and predict a data object with future time series data that will be generated in a near future and satisfy a predetermined growth trend from data objects included in the feature category objects, i.e., a target data object that will be outburst. Based on the principles of time series data, the embodiments of the present disclosure predict a target data object that will have an explosive power in a near future, and enable a prediction result to fit with the reality in a better manner, having a higher accurate rate.

### BRIEF DESCRIPTION OF THE DRAWINGS

FIGS. 1A-D are flowcharts of a time series based data prediction method in accordance with a first embodiment of the present disclosure.

FIG. 2 is a schematic diagram of a category tree of the time series based data prediction method in accordance with the first embodiment of the present disclosure.

FIGS. 3A-E are flowcharts of a time series based data prediction method in accordance with a second embodiment of the present disclosure.

FIG. 4 is a structural block diagram of a time series based data prediction apparatus in accordance with an embodiment of the present disclosure.

### DETAILED DESCRIPTION

In order to make the above goals, features and advantages of the present disclosure to be understood more easily, the present disclosure is described in further detail in conjunction with accompanying drawings and specific embodiments.

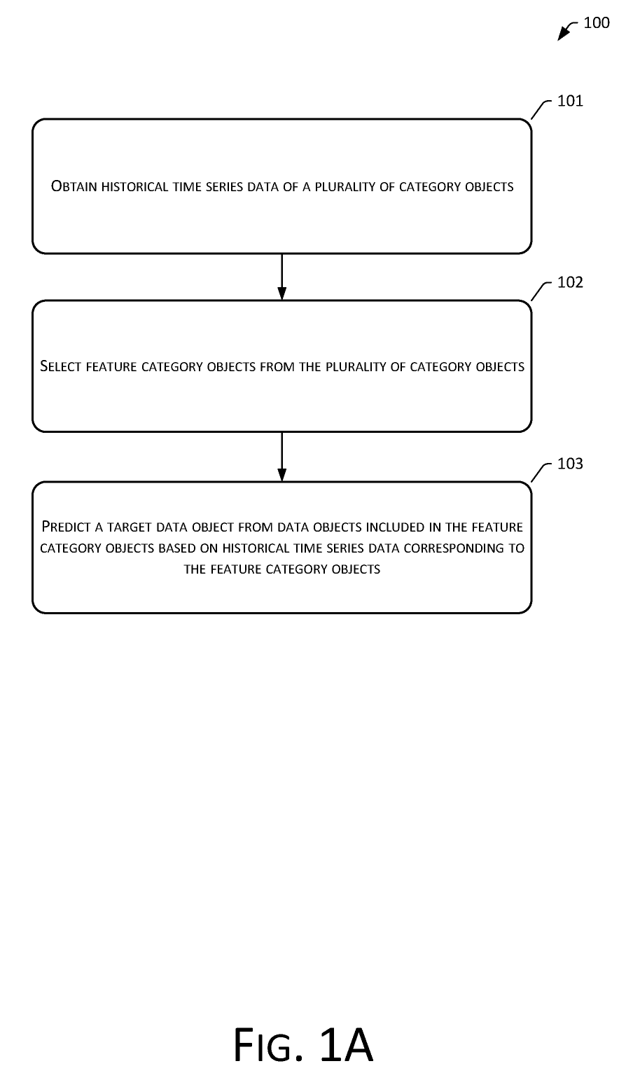

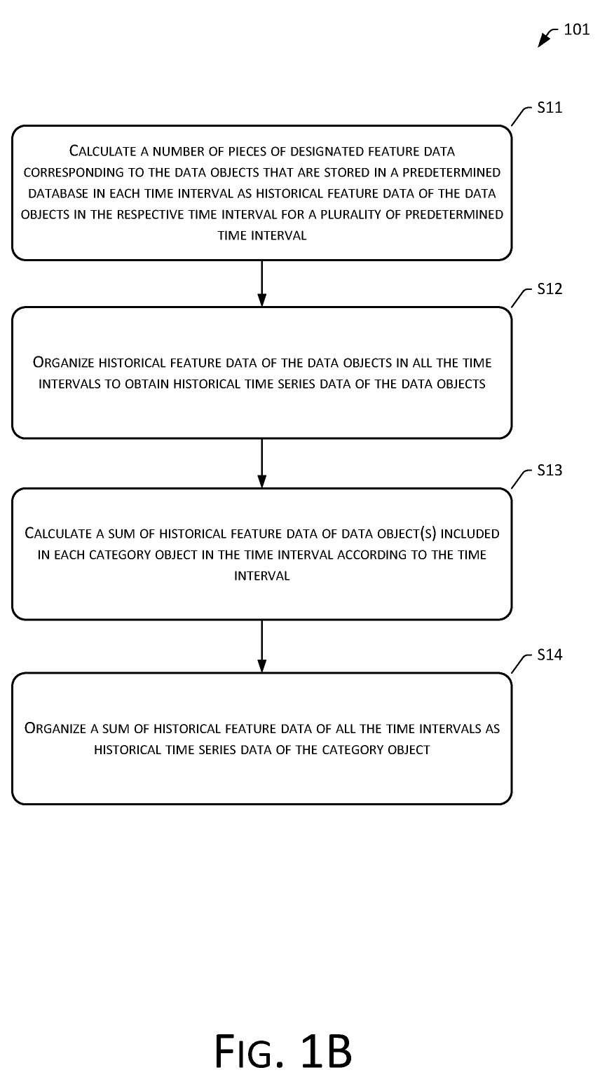

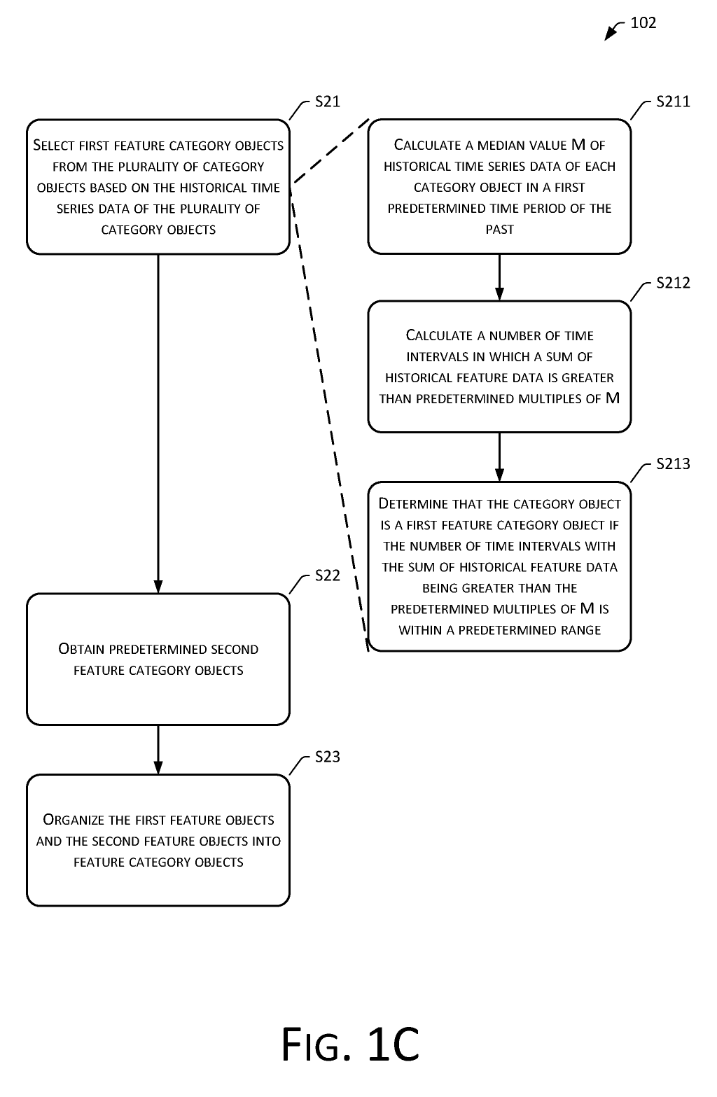

FIGS. 1A-D show flowcharts of a time series based data prediction method 100 in accordance with a first embodiment of the present disclosure. The embodiments of the present disclosure can applied in platforms having a tree category system such as electronic commerce platforms. A tree category system can be a method of obtaining categories by classifying data according to a tree classification. A tree classification is an image classification, making classification level by level according to levels, such as a tree having leaves, branches, trunks, roots.

For example, in order to adapt consumer groups nowadays to have well-directed purchases of various types of commodities on an online store in an electronic commerce platform, a tree classification can be used for classifying commodities to obtain commodity categories, such as fashion, accessories, beauty, digital, home & garden, infant & mom, food, recreation and sports, services, and insurance, etc.

As shown in FIG. 1, the method 100 can include the following operations.

Operation 101 obtains historical time series data of a plurality of category objects.

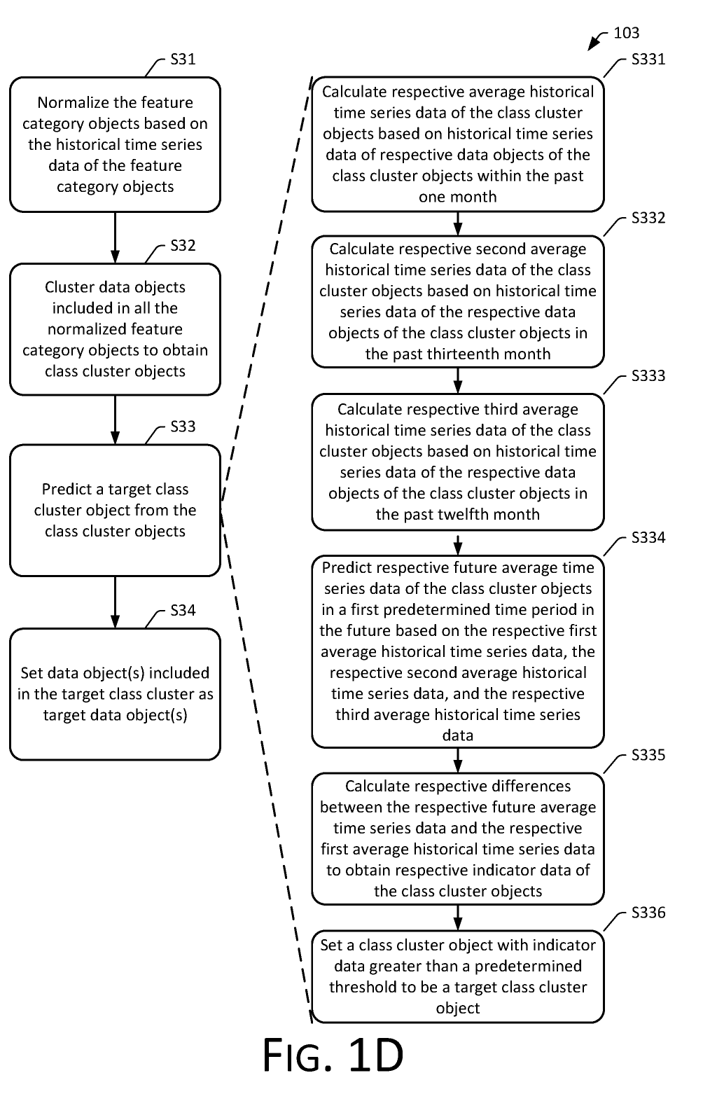

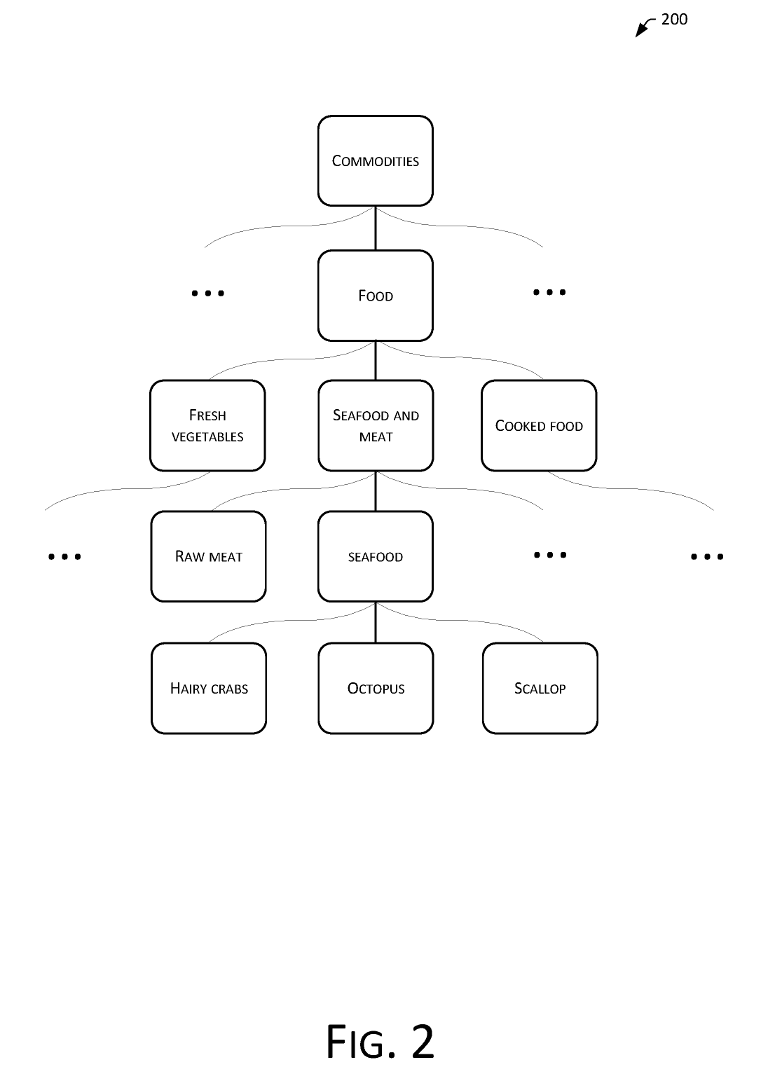

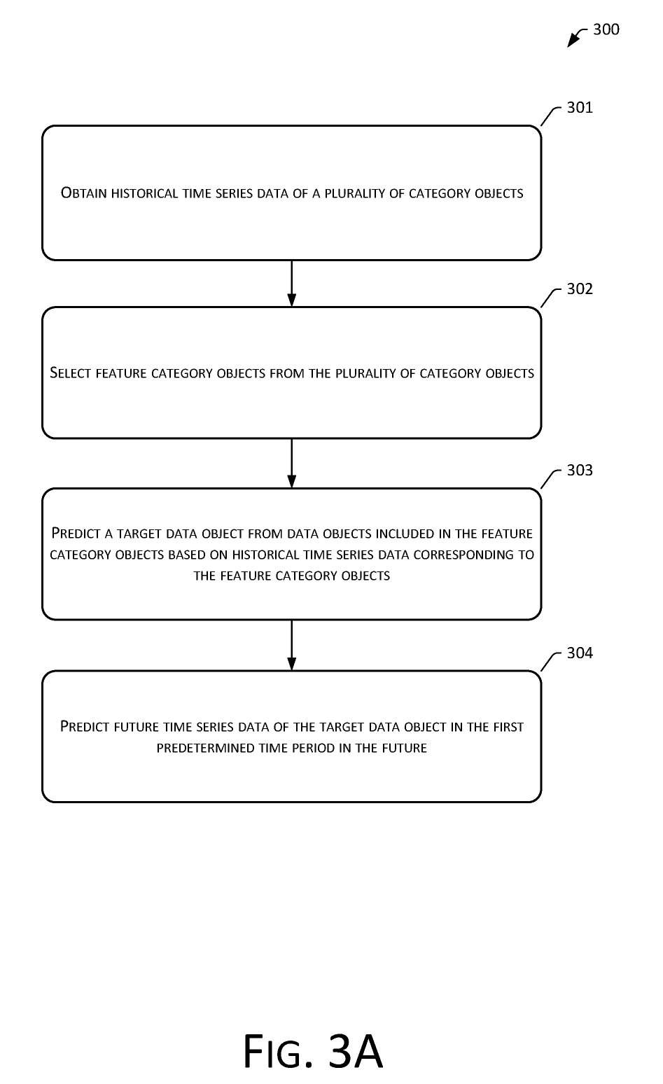

For applying to the embodiments of the present disclosure, a category object may include one or more data objects. For example, in an electronic commerce platform, under a commodity category such as “seafood” in a schematic diagram of a classification tree 200 as shown in FIG. 2, commodity data such as “hairy crabs”, “octopus”, “scallop”, etc., can be included.

Furthermore, each data object has multiple pieces of corresponding designated feature data. The designated feature data is generated in advance, and is a record generated when an occurrence of a designated activity associated with the data object is detected. For example, in an electronic commerce platform, the designated activity may include a sales activity, and the designated feature data may be a sales record generated in response to an occurrence of a sales activity of a certain commodity.

In implementations, designated feature data of a data object can be obtained from a predetermined database. The predetermined database can be a database that is generated in advance. For example, the predetermined database may be a commodity database, and the commodity database stores a number of sales records associated with one or more commodities.

In practice, the predetermined database may also store data property information of data objects. As an example, the data property information may include time property information, identification property information, feature property information, etc. For example, a commodity database may also store commodity property information of each commodity. The commodity property information may include basic propert(ies), time propert(ies), transaction propert(ies), credibility propert(ies), and sales propert(ies), etc., of a commodity. The basic propert(ies) of the commodity may include a name, a belonging merchant ID, a price, a time duration of sales, a belonging category, etc., of the commodity. The time propert(ies) may include time information of an occurrence of an activity such as a purchase activity, a comment activity, and/or a sales activity, etc. The transaction propert(ies) of the commodity may include collection, added purchase, and/or purchase of the commodity. The credibility propert(ies) of the commodity may include a merchant star level, a number of negative comments, a rate of negative comments, a logistics score, etc. The sales propert(ies) of the commodity may include whether the commodity is a hot commodity, whether the commodity is a commodity of promotion, etc.

In implementations, operation 101 may include the following sub-operations.

Sub-operation S11 calculates a number of pieces of designated feature data corresponding to the data objects that are stored in a predetermined database in each time interval as historical feature data of the data objects in the respective time interval for a plurality of predetermined time interval.

In implementations, a time interval can be an interval set according to a space of time. For example, the space of time may be one day, half day, one week, or one month, etc. If a space of time is one day, a time interval may be [00:00, 23:59] in each day. Apparently, the time interval may also be added with date information. For example, a time interval of 2015-11-18 may be [2015-11-18-00:00, 2015-11-18-23:59]. The predetermined time interval may be a time interval set by a developer in advance.

After obtaining a plurality of predetermined time intervals, a number of pieces of designated feature data of the data objects in each time interval (e.g., in each day) may further be calculated to obtain historical feature data of the respective time interval. For example, a daily number of sales records for a certain commodity are calculated to obtain a daily sales volume.

Sub-operation S12 organizes historical feature data of the data objects in all the time intervals to obtain historical time series data of the data objects.

After obtaining the historical feature data of the data objects in each time interval, historical feature data of all the time intervals is organized, and historical time series data of the data objects can be obtained. Time series data refers to data collected in different time points. This type of data reflects a state or degree that changes along with time such as a certain matter, phenomenon, etc. Time series data is a special form of existence of data. A past value of a series affects a future value. A magnitude of this type of influence and a manner of influence can be depicted by activities such as a trend cycle and non-stationary in time series data. A time series essentially mines a prediction of a future value based on a trend of change of data as time goes by. An important point to consider is a specific characteristic of time, such as influences that may be caused by some periodic time definition such as week, month, season, year, etc., or different days such as holidays, etc. A method of calculating a date itself also has some aspects that need special consideration, such as a correlation before and after a time (how much does a past event affect the future), etc. Only after time factors are fully considered and a series of values of current data that changes along with time are used, a better prediction of a future value can be made.

For example, after daily sales volumes of a commodity are obtained, a historical sales volume of the commodity is obtained by organizing a respective daily sales volume of each day.

Historical time series data of a data object can reflect a trend of that data object in a certain time period in the past.

Sub-operation S13 calculates a sum of historical feature data of data object(s) included in each category object in the time interval according to the time interval.

Since a category object may include one or more data objects, a sum of historical feature data of all data objects in the category object can be calculated in a time interval using this time interval as a unit, after historical feature data of each data object under the category object is obtained.

For example, in a certain day, under a category of “seafood”, a daily sales volume of “hairy crabs” is 1000 jin, a daily sales volume of “octopus” is 500 jin, and a daily sales volume of “scallop” is 300 jin. As such, a sum of daily sales volumes under the category of “seafood” in this date is 1800 jin.

Sub-operation S14 organizes a sum of historical feature data of all the time intervals as historical time series data of the category object.

Historical time series data of the category object can be obtained by organizing a sum of historical feature data of all the time intervals.

For example, after sums of daily sales volumes of each day for a category of “seafood” in the past one month is obtained, historical time series data of the category of “seafood” in that month can be obtained by organizing all the sums of daily sales volumes of that month.

In implementations, operation 101 can be completed by a category data generator. This generator generates historical time series data of each category object based on a tree classification system of a current platform. After operation 101, an originally tremendous amount of historical time series data of data objects can be consolidated into historical time series data of various category objects, thus providing a strong data support for subsequent operations.

Operation 102 selects feature category objects from the plurality of category objects.

In the embodiments of the present disclosure, after historical time series data of each category object is obtained, feature category objects can be further selected from the plurality of category objects. A feature category object can be a category object having a feature data object. A feature data object may be a data object with a life cycle less than a predetermined time threshold, i.e., a time-sensitive data object. For example, when the category object is a commodity category, the feature category object may be a time-sensitive commodity category. A time sensitive commodity category can be a category object having time sensitive commodities. A time sensitive commodity is a commodity having a certain time sensitive characteristic of consumption and having a very short expiration date. Examples are moon cakes, hairy crabs, etc. Time sensitive commodity categories may include fresh food categories such as vegetables, fruits, seafood, raw meat, cooked meat, etc.

In implementations, operation 102 may include the following sub-operations.

Sub-operation S21 selects first feature category objects from the plurality of category objects based on the historical time series data of the plurality of category objects.

After historical time series data of all category objects of a current platform is obtained, first feature category objects can be selected from the category objects based on the historical time series data of the category objects.

In implementations, operation S21 may further include the following sub-operations.

Sub-operation S211 calculates a median value M of historical time series data of each category object in a first predetermined time period of the past.

Specifically, a median value is also called a median, and is a value located at the middle of a group of data (special attention is made that this group of data has been arranged in an ascending order or descending order). In other words, in this group of data, half of the data is larger than the median value, and another half of the data is smaller than the median value. If this group of data includes an even number of values, the median value is an average of the two values at the middle. If n number of data exists, a median is an average of an n/2 th value and a (n+2)/2 th value when n is an even number. If n is an odd number, a median is a (n+1)/2 th value.

In implementations, a time range of historical time series data of each category object can be defined as a first predetermined time period in the past. For example, a first predetermined time period in the past can be set as the past year. Historical time series data of each category object can be arranged in an ascending order or descending order. In other words, respective sums of historical time series data of the category object corresponding to all time intervals in the past year are ordered, and a median value M of the category object is obtained after ordering. For example, after a sum of daily sales volumes of each commodity category in each day of the past year is ordered, a sum of daily sales volumes located at the middle is obtained as a median value M of the commodity category in the past year.

It should be noted that a median value, not an average value, is calculated here, because an average value is prone to an influence of extreme values in a group of data, and a median value is not affected by the extreme values, thus making a prediction that is fitted with an actual situation.

Sub-operation S212 calculates a number of time intervals in which a sum of historical feature data is greater than predetermined multiples of M.

After the median value M is obtained, M is increased by n times, for example, 1.5 times (which can be represented as 1.5M). A sum of historical feature data of the category object in each time interval is compared with 1.5M, to obtain a number of time intervals with a sum of historical feature data being greater than 1.5M. For example, a number of days in which a sum of daily sales volumes of a commodity category is greater than 1.5M are calculated.

Sub-operation S213 determines that the category object is a first feature category object if the number of time intervals with the sum of historical feature data being greater than the predetermined multiples of M is within a predetermined range.

If M is increased by 1.5 times and the number of time intervals with a sum of historical feature data being greater than 1.5M is within a predetermined range, the category object can be determined to be a first feature category object.

For example, a value of the predetermined range is set as 10-45. If the number of days in which a sum of daily sales volumes of a commodity category is greater than 1.5M is within this range, the commodity category is determined to be a time sensitive commodity category.

Sub-operation S22 obtains predetermined second feature category objects.

For applying to the embodiments of the present disclosure, predetermined second feature category objects may be category objects in a white list. The white list can be manually selected in advance. For example, time sensitive commodity categories can be commodity categories that are selected by an operator in advance, and these selected commodity categories are added into a white list.

Sub-operation S23 organizes the first feature objects and the second feature objects into feature category objects.

After the first feature objects and the second feature objects are obtained, the first feature objects and the second feature objects can be organized as feature category objects. A method of organization can include a method of de-replication, i.e., removing feature category objects that are duplicated in the first feature objects and the second feature objects, and outputting all feature category objects.

In the embodiments of the present disclosure, a selection of feature category objects can be performed automatically and manually, so that a selection result can satisfy needs of a user in a better manner, being more complete and having a high degree of intelligentization.

Operation 103 predicts a target data object from data objects included in the feature category objects based on historical time series data corresponding to the feature category objects.

After feature category objects are determined, a target data object can be selected from data objects included in the feature category objects. The target data object is a data object of which future time series data to be generated in a first predetermined time period in the future satisfies a predetermined growth trend, i.e., a data object of which an explosive number is generated in a recent time.

In implementations, in order to improve the reliability of a prediction result, the first predetermined time period in the future can be a time period in a recent time, for example, may include a medium time period or a short time period in the future. As an example, the medium time period may be one month, i.e., the first predetermined time period in the future is the following one month since a current time. The short time period may be a short term such as half month, one week, etc, i.e., the first predetermined time period in the future is the following half month or one week since a current time.

The target data object can be a data object of which future time series data to be generated satisfies a predetermined growth trend, i.e., a data object of which a number to be generated has an abnormal point or a breaking point. For example, prior to moon festival, the sales volume of moon cakes would be increased explosively, and moon cakes can be a target data object.

Applying to the embodiments of the present disclosure, after feature category objects are determined, a target data object can further be selected from data objects included in the features category objects. For example, after time sensitive commodity categories are determined, time sensitive target commodities that will be in hot sale (generating a breaking point or an abnormal point) recently can further be selected from time sensitive commodities included in the time sensitive commodity categories.

In implementations, operation 103 may include the following sub-operations.

Sub-operation S31 normalizes the feature category objects based on the historical time series data of the feature category objects.

After feature category objects are determined, in order to eliminate differences among various data objects in the feature category objects to obtain a more accurate prediction result, normalization can be performed on the feature category objects. Normalization is a way of simplification, i.e., changing a dimensional representation into a non-dimensional representation to become a scalar quantity through conversion.

In implementations, the following approach can be used to perform normalization on the feature category objects:

based on a median value M of historical time series data of a feature category object in a first predetermined time period of the past that is obtained according to operation S211, separately calculating respective ratios between a sum of each historical feature data in the historical time series data and the median value M, to obtain normalized sums of historical feature data; and organizing the normalized sums of historical feature data to form normalized historical time series data of the feature category object.

Apparently, the embodiments of the present disclosure are not limited to the above approach of normalization. One skilled in the art can employ other normalization approaches.

Sub-operation S32 clusters data objects included in all the normalized feature category objects to obtain class cluster objects.

Applying to the embodiments of the present disclosure, after the historical time series data of the feature category objects are normalized, clustering can further be performed on all the feature category objects. In practice, this clustering can be a clustering performed on all data objects included in the all the feature category objects, aggregating data objects having similar trends in the historical time series data together to obtain one or more class cluster objects.

Specifically, a process of forming multiple classes each being made up of similar objects from a set of physical or abstract objects is called clustering. A class cluster generated by clustering is a set of objects. These objects are similar to objects in the same cluster, and are different from objects in other clusters. In implementations, a number of different clustering methods can be used for performing clustering. Examples are a hierarchical clustering, a clustering by division, a density-based clustering, a grid-based clustering, a model-based clustering, etc. The embodiments of the present disclosure do not have any limitation on the details of a clustering method.

For example, the feature category objects that are obtained are a category of fruits, a category of seafood, and a category of cooked food, etc. These three category objects can be separately normalized. Commodities included in the normalized category objects are clustered, and commodities having similar explosive power are aggregated together to obtain one or more class clusters. For example, since hairy crabs are most delicious around moon festival, hairy crabs can reach high level of sales together than moon cakes around the moon festival. Trends of historical time series data of these two are similar, and therefore hairy crabs and moon cakes can be placed in a same class cluster.

Sub-operation S33 predicts a target class cluster object from the class cluster objects.

After class cluster objects are obtained, a class cluster object that would experience an outburst in a recent time period (a first predetermined time period in the future) can be selected to be a target class cluster object from among the class cluster objects. For example, a class cluster object to be a hot sale is selected to be a target class cluster object from a plurality of class cluster objects.

In implementations, sub-operation S33 may further include the following sub-operations.

Sub-operation S331 calculates respective average historical time series data of the class cluster objects based on historical time series data of respective data objects of the class cluster objects within the past one month.

In implementations, based on normalized historical time series data of each data object in a class cluster object within the past one month (the most recent one month), an average value of historical time series data of all the data objects under the class cluster object is calculated. In other words, using a time interval as a unit (for example, using a day as a unit), an average value under this time interval is obtained by dividing a sum of normalized historical feature data of all data objects under the class cluster object within the time interval by the number of all the data objects within the time interval. Average values of all time intervals form first average historical time series data of the class cluster object.

Sub-operation S332 calculates respective second average historical time series data of the class cluster objects based on historical time series data of the respective data objects of the class cluster objects in the past thirteenth month.

In implementations, based on normalized historical time series data of each data object in a class cluster object within the past thirteenth month (one year before the most recent one month), an average value of historical time series data of all the data objects under the class cluster object is calculated. In other words, using a time interval as a unit (for example, using a day as a unit), an average value under this time interval is obtained by dividing a sum of normalized historical feature data of all data objects under the class cluster object within the time interval by the number of all the data objects within the time interval. Average values of all time intervals form second average historical time series data of the class cluster object.

Sub-operation S333 calculates respective third average historical time series data of the class cluster objects based on historical time series data of the respective data objects of the class cluster objects in the past twelfth month.

The method of operation S332 is used to calculate respective third average historical time series data of the class cluster objects, i.e., calculating average normalized data in one year before a current date.

Sub-operation S334 predicts respective future average time series data of the class cluster objects in a first predetermined time period in the future based on the respective first average historical time series data, the respective second average historical time series data, and the respective third average historical time series data.

In implementations, after first average historical time series data is obtained, a first average value of the first average historical time series data can further be calculated (a sum of average values under each time interval of a class cluster divided by a number of time intervals). Also, after second average historical time series data is obtained, a second average value of the second average historical time series data can further be calculated (a sum of average values under each time interval of a class cluster divided by a number of time intervals).

A ratio between the first average value and the second average value is calculated to obtain a ratio value A.

The third average historical time series data is separately multiplied by the ratio value A, to obtain future average time series data of the feature category object in a first predetermined time period in the future.

It should be noted that the first predetermined time period in the future may be a time period using a standard of the lunar calendar. If an important holiday in the Gregorian calendar (such as national holiday, New Year's day, etc.) appears in a certain time interval in the first predetermined time period, a corresponding correction is made according to the holiday in the Gregorian calendar. In other words, in this holiday, the standard of the lunar calendar is changed to a corresponding standard of the Gregorian calendar, with other non-important holidays being unchanged.

Sub-operation S335 calculates respective differences between the respective future average time series data and the respective first average historical time series data to obtain respective indicator data of the class cluster objects.

After future average time series data in the first predetermined time period in the future is obtained, a first sum of the future average time series data (a sum of average values of a class cluster in each time interval) can further be calculated, and a second sum of the first average time series data can be calculated.

A difference between the first sum and the second sum can then be calculated to obtain indicator data of the class cluster object.

Sub-operation S336 sets a class cluster object with indicator data greater than a predetermined threshold to be a target class cluster object.

After indicator data of class cluster objects is obtained, a class cluster object with a larger indicator data is selected to be a target class cluster object. In implementations, a class cluster object with indicator data greater than a predetermined threshold can be selected to be a target class cluster object.

For example, indicator data of two class clusters is separately obtained as follows (M is a median value of normalized historical time series data):

Hairy crabs+moon cakes (first class cluster): 1.1M

Octopus (second class cluster): −0.01M

After arranging in an order, a determination can be made that the sales volume of the first class cluster (i.e., hairy crabs and moon cakes) will be explosively increased in the coming half month, while the sales volume of the octopus remains stable.

In the embodiments of the present disclosure, the potential of short-term and medium medium-term outburst of a class cluster object can be determined based on explosive power indicator data thereof.

Sub-operation S34 sets data object(s) included in the target class cluster object as target data object(s).

After a target class cluster object is determined, data object(s) included in the target class cluster object can be set as target data object(s).

The embodiments of the present disclosure can select time-sensitive and seasonal feature category objects from a plurality of category objects, and predict a target data object that will be outburst in a near future from among data objects included in the feature category objects. Based on the principles of time series data, the embodiments of the present disclosure predict a target data object that will have an explosive power in a near future, and enable a prediction result to fit with the reality in a better manner, having a higher accurate rate.

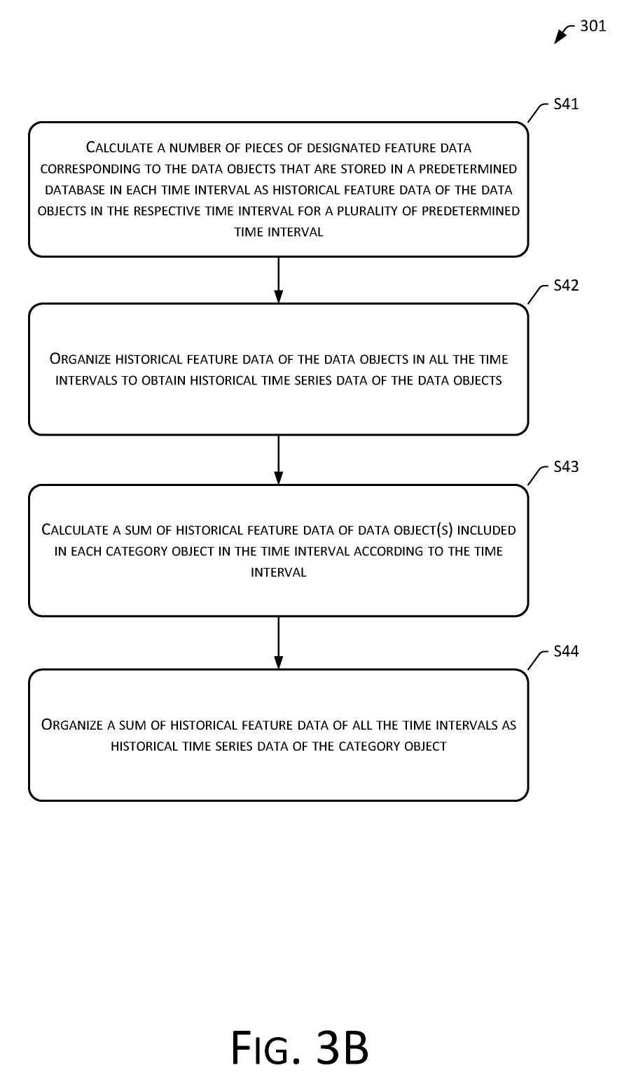

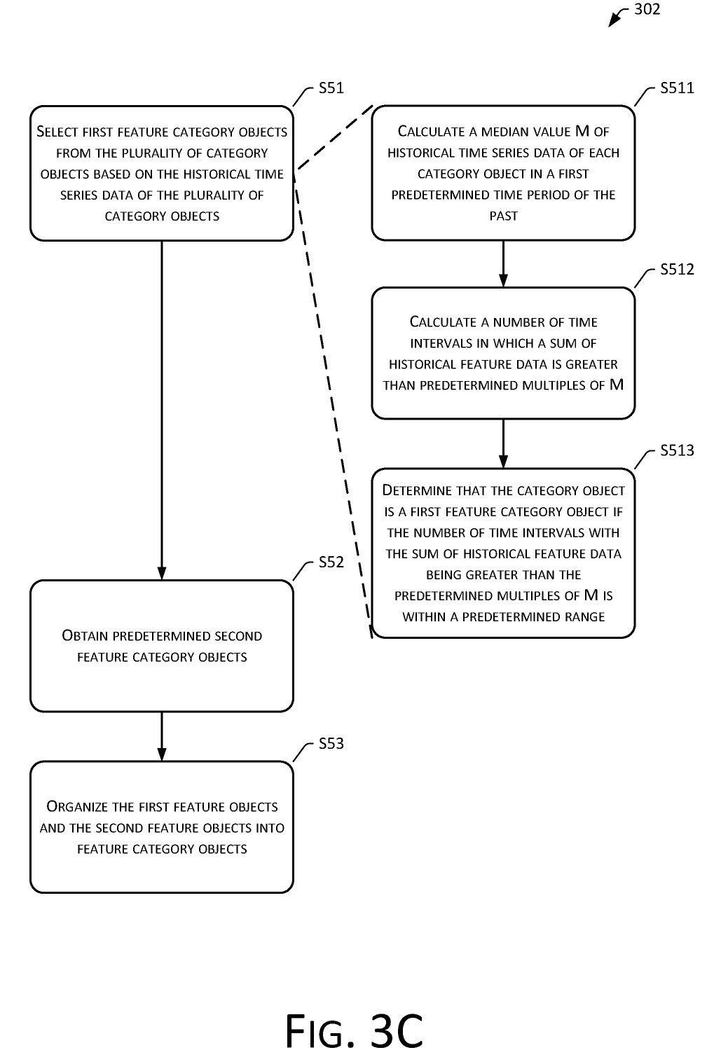

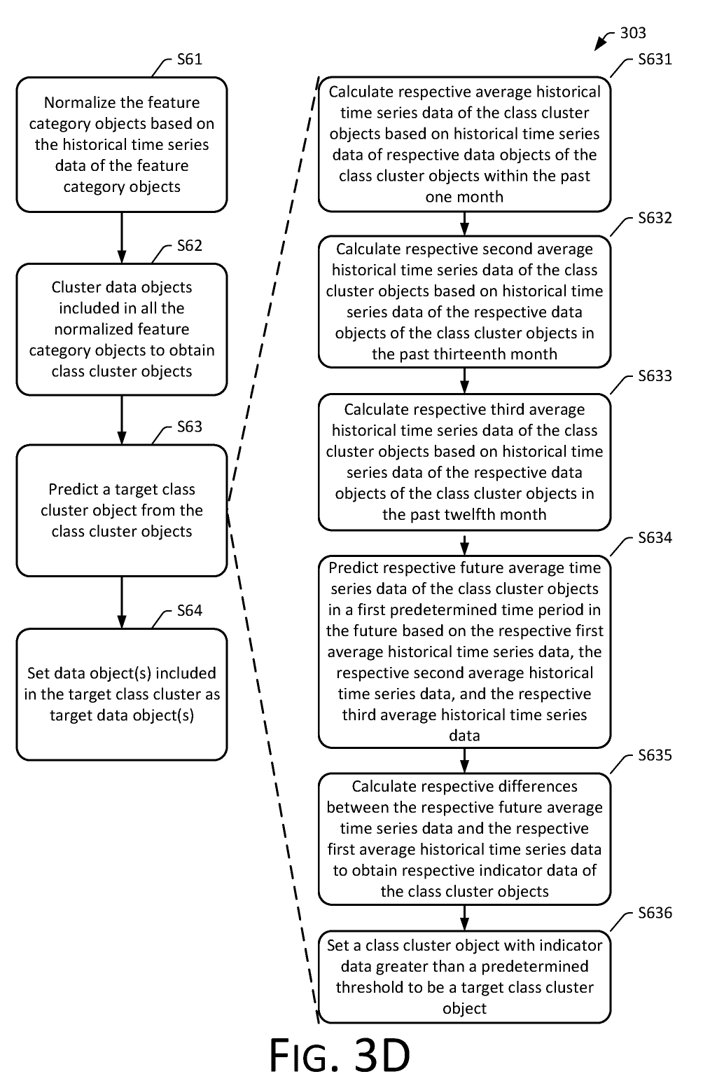

FIGS. 3A-E show flowcharts of a time series based data prediction method 300 in accordance with a second embodiment of the present disclosure. In implementations, the method 300 may include the following operations.

Operation 301 obtains historical time series data of a plurality of category objects.

Applying to the embodiments of the present disclosure, a category object may include one or more data objects.

In implementations, operation 301 may include the following sub-operations.

Sub-operation S41 calculates a number of pieces of designated feature data corresponding to the data objects that are stored in a predetermined database in each time interval as historical feature data of the data objects in the respective time interval for a plurality of predetermined time interval.

Sub-operation S42 organizes historical feature data of the data objects in all the time intervals to obtain historical time series data of the data objects.

Sub-operation S43 calculates a sum of historical feature data of data object(s) included in each category object in the time interval according to the time interval.

Sub-operation S44 organizes a sum of historical feature data of all the time intervals as historical time series data of the category object.

Operation 302 selects feature category objects from the plurality of category objects.

In the embodiments of the present disclosure, after historical time series data of each category object is obtained, feature category objects can be further selected from the plurality of category objects. A feature category object can be a category object having a feature data object. A feature data object may be a data object with a life cycle less than a predetermined time threshold, i.e., a time-sensitive data object.

Sub-operation S51 selects first feature category objects from the plurality of category objects based on the historical time series data of the plurality of category objects.

In implementations, operation S51 may further include the following sub-operations.

Sub-operation S511 calculates a median value M of historical time series data of each category object in a first predetermined time period of the past.

Sub-operation S512 calculates a number of time intervals in which a sum of historical feature data is greater than predetermined multiples of M.

Sub-operation S513 determines that the category object is a first feature category object if the number of time intervals with the sum of historical feature data being greater than the predetermined multiples of M is within a predetermined range.

Sub-operation S52 obtains predetermined second feature category objects.

Sub-operation S53 organizes the first feature objects and the second feature objects into feature category objects.

Operation 303 predicts a target data object from data objects included in the feature category objects based on historical time series data corresponding to the feature category objects.

After feature category objects are determined, a target data object can be selected from data objects included in the feature category objects. The target data object may be a data object of which future time series data to be generated in a first predetermined time period in the future satisfies a predetermined growth trend.

In implementations, operation 303 may include the following sub-operations.

Sub-operation S61 normalizes the feature category objects based on the historical time series data of the feature category objects.

Sub-operation S62 clusters data objects included in all the normalized feature category objects to obtain class cluster objects.

Sub-operation S63 predicts a target class cluster object from the class cluster objects.

In implementations, sub-operation S63 may further include the following sub-operations.

Sub-operation S631 calculates respective average historical time series data of the class cluster objects based on historical time series data of respective data objects of the class cluster objects within the past one month.

Sub-operation S632 calculates respective second average historical time series data of the class cluster objects based on historical time series data of the respective data objects of the class cluster objects in the past thirteenth month.

Sub-operation S633 calculates respective third average historical time series data of the class cluster objects based on historical time series data of the respective data objects of the class cluster objects in the past twelfth month.

Sub-operation S634 predicts respective future average time series data of the class cluster objects in a first predetermined time period in the future based on the respective first average historical time series data, the respective second average historical time series data, and the respective third average historical time series data.

Sub-operation S635 calculates respective differences between the respective future average time series data and the respective first average historical time series data to obtain respective indicator data of the class cluster objects.

Sub-operation S636 sets a class cluster object with indicator data greater than a predetermined threshold to be a target class cluster object.

Sub-operation S64 sets data object(s) included in the target class cluster object as target data object(s).

Operation 304 predicts future time series data of the target data object in the first predetermined time period in the future.

In implementations, operation 304 may include the following sub-operations.

Sub-operation S71 de-normalizes the respective future average time series data of the class cluster objects in the first predetermined time period in the future, to obtain standard average time series data of each data object in the class cluster objects.

Since the respective future average time series data of the class cluster objects predicted at sub-operation S634 is normalized values, de-normalization can first be performed on these normalized values, i.e., multiplying the respective future average time series data by respective median values M to obtain standard average time series data of each data object in the class cluster objects.

Sub-operation S72 corrects the standard average time series data of each data object in the class cluster objects, to obtain corresponding future time series data of the respective data objet in the first predetermined time period in the future.

After the standard average time series data of each data object is obtained, correction can be performed on the standard average time series data to obtain future time series data of the respective data objet in the first predetermined time period in the future. In implementations, the correction may include an offset correction of magnification or reduction performed according to predetermined reference parameter(s).

The predetermined reference parameter(s) may be offset parameters in other databases. For example, in an electronic commerce platform, in order to cope with the influence caused by changes in number of merchants on the platform, the predetermined reference parameter(s) may be data in a merchant database. The merchant database records various merchants of the platform, and main features thereof, which include properties of the merchants such as basic properties, transaction properties and credibility properties. Corrections such as magnification (or reduction) of standard average time series data can be performed using a comparison between the number of merchants at a current period of time and the number of merchants in the same period of time last year, to obtain future time series data of a commodity category.

For example, in comparison between a same period of time in this year and last year, the number of merchants stored in a merchant database increases from 100 to 1000. The number of merchants increases by 10 times, and the sales volume increases by 20 times. Therefore, standard average time series data may be multiplied by two to obtain future time series data.

In implementations, if the embodiments of the present disclosure are applied in an electronic commerce platform, a data object can be commodity data, a category object can be a commodity category, a feature category object can be a time sensitive commodity category, a life cycle can be an expiration date of a commodity, and time series data can be a daily sales volume of the commodity.

The embodiments of the present disclosure can select time-sensitive and seasonal feature category objects from a plurality of category objects, predict a target data object that will be outburst in a near future from among data objects included in the feature category objects, and predict future time series data of the target data object in the near future. Based on the principles of time series data, the embodiments of the present disclosure predict a target data object that will have an explosive power and future time series data of the target data object in a near future, and enable a prediction result to fit with the reality in a better manner, having a higher accurate rate.

Since the method embodiment of FIG. 3 is basically similar to the method embodiment of FIG. 3, a description thereof is relatively simple. For related portions, reference can be made to the description of the portions of the method embodiment.

It should be noted that the method embodiments are represented as series of combinations of actions for the sake of description. However, one skilled in the art should understand that the embodiments of the present disclosure are not limited to the described orders of actions, because certain operations can be performed in other orders or in parallel according to the embodiments of the present disclosure. Moreover, one skilled in the art should also understand that the embodiments described in the specification are exemplary embodiments. Actions involved therein may not necessarily be essential to the embodiments of the present disclosure.

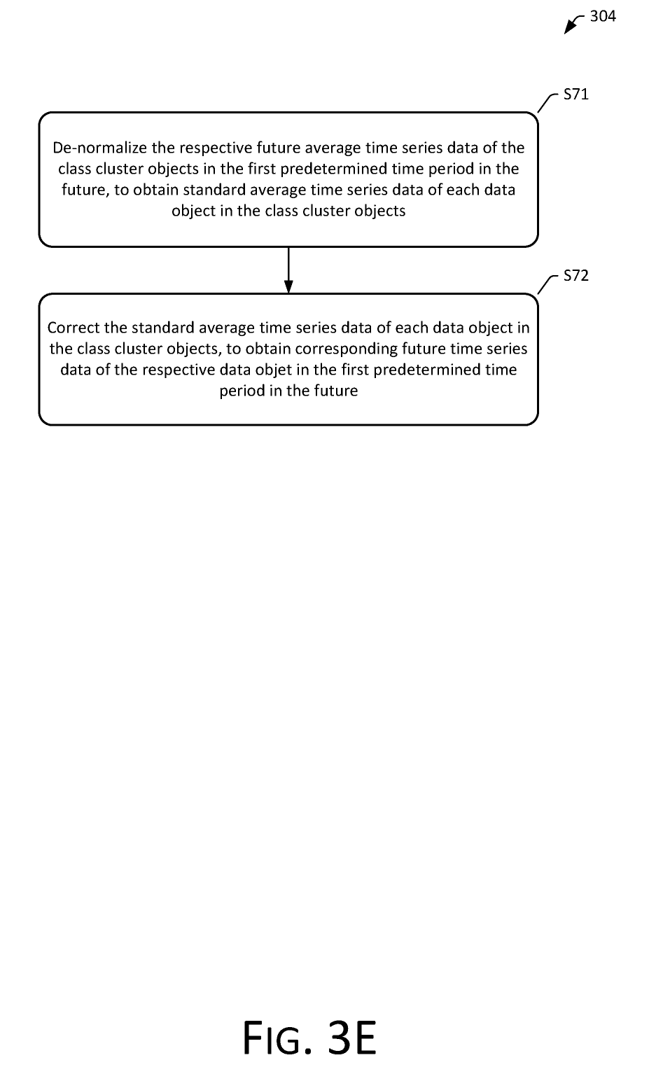

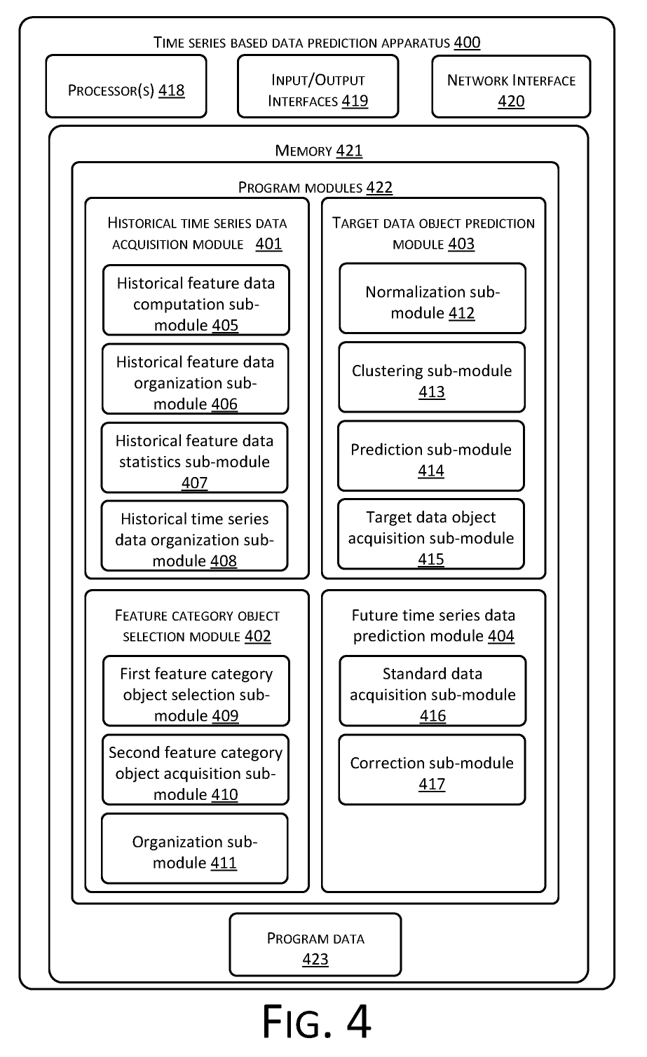

FIG. 4 shows a structural block diagram of a time series based data prediction apparatus 400 in accordance with the embodiments of the present disclosure. In implementations, the apparatus 400 may include one or more computing devices. In implementations, the apparatus 400 may be a part of one or more computing devices, e.g., run or implemented by the one or more computing devices. The one or more computing devices may be located in a single place or distributed among a plurality of network devices connected through a network, e.g., a cloud. By way of example and not limitation, the apparatus 400 may include the following modules.

A historical time series data acquisition module 401 is used for obtaining historical time series data of a plurality of category objects, the category objects including one or more data objects.

A feature category object selection module 402 is used for selecting feature category object(s) from the plurality of category objects, the feature category object(s) being category object(s) including a respective feature data object, and the respective feature data object being a data object having a life cycle less than a predetermined time threshold.

A target data object prediction module 403 is used for predicting a target data object from among data object(s) included in the feature category object(s) based on historical time series data corresponding to the feature category object(s), the target data object being a data object with future time series data that is generated in a future first predetermined time period and satisfies a predetermined growth trend.

In implementations, the apparatus may further include a future time series data prediction module 404 used for predicting the future time series data of the target data object in the future first predetermined time period.

In implementations, the historical time series data acquisition module 401 includes a historical feature data computation sub-module 405 used for calculating an amount of designated feature data corresponding to the data object that is stored in a predetermined database in each time interval as historical feature data of the data object in the respective time interval, for a plurality of predetermined time intervals; a historical feature data organization sub-module 406 used for organizing historical feature data of the data object in all the time intervals to obtain historical time series data of the data object; a historical feature data statistics sub-module 407 used for calculating a sum of historical feature data of data objects included in each category object in the respective time interval according to the respective time interval; and a historical time series data organization sub-module 408 used for organizing respective sums of historical feature data of all the time interval as historical time series data of the respective category object.

In implementations, the feature category object selection module 402 includes a first feature category object selection sub-module 409 used for selecting a first feature category object from the plurality of category objects based on the historical time series data of the plurality of category objects; a second feature category object acquisition sub-module 410 used for obtaining a predetermined second feature category object; and an organization sub-module 411 used for organizing the first feature category object and the second feature category object as a feature category object.

In implementations, the first feature category object selection sub-module 409 is further used for calculating a median value M of historical time series data of each category object in a previous first predetermined time period; calculating a number of time intervals in which a sum of historical feature data is greater than a predetermined multiple of M; and determining that the category object is the first feature category object if the number of intervals in which the sum of historical feature data is greater than the predetermined multiple of M is within a predetermined range.

In implementations, the target data object prediction module 403 includes a normalization sub-module 412 used for normalizing the feature category object(s) based on the historical time series data corresponding to the feature category object(s); a clustering sub-module 413 used for clustering the data object(s) included in the normalized feature category object(s) to obtain class cluster object(s); a prediction sub-module 414 used for predicting a target class cluster object from the class cluster object(s); and a target data object acquisition sub-module 415 used for setting a data object included in the target class cluster object as the target data object.

In implementations, the prediction sub-module 414 is further used for calculating first average historical time series data of the class cluster object(s) based on historical time series data of data objects in the class cluster object(s) in a previous one month; calculating second average historical time series data of the class cluster object(s) based on historical time series data of data objects in the class cluster object(s) in a previous thirteenth month; calculating third average historical time series data of the class cluster object(s) based on historical time series data of data objects in the class cluster object(s) in a previous twelfth month; predicting future average time series data of the class cluster object(s) in the future first predetermined time period based on the first average historical time series data, the second average historical time series data and the third average historical time series data; calculating a difference between the future average time series data and the first average historical time series data to obtain indicator data of the class cluster object(s); and setting a class cluster object having indicator data greater than a predetermined threshold as the target class cluster object.

In implementations, the future time series data prediction module 404 includes a standard data acquisition sub-module 416 used for normalizing future average time series data of the class cluster object(s) in the future first predetermined time period to obtain a standard average time series data of each data object in the class cluster object(s); and a correction sub-module 417 used for correcting the standard average time series data of each data object to obtain future time series data of the respective data object in the future first predetermined time period.

In implementations, the data object is commodity data, the category objects are commodity categories, the feature category object(s) is/are time-sensitive commodity categor(ies), the life cycle is a time limit of a commodity, and the time series data is a daily sales volume of the commodity.

In implementations, the apparatus 400 may also include one or more processors 418, an input/output (I/O) interface 419, a network interface 420, and memory 421.

In a typical configuration, a computing device includes one or more processors (CPU), an input/output interface, a network interface, and memory. The memory 421 may include a form of computer readable media such as a volatile memory, a random access memory (RAM) and/or a non-volatile memory, for example, a read-only memory (ROM) or a flash RAM. The memory 421 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 421 may include program modules 422 and program data 423. The program modules 422 may include one or more of the foregoing modules/sub-modules as described in the foregoing description.

Since the apparatus embodiment is basically similar to the method embodiment, a description thereof is relatively simple. For related portions, reference can be made to the description of the portions of the method embodiment.

The embodiments are described in a progressive manner in the specification. The description of each embodiment has a focus that is different from other embodiments. Same and similar portions among the embodiments can be referenced with each other.

One skilled in the art should understand that an embodiment of the present disclosure can be provided as a method, an apparatus, or a computer program product. Therefore, the embodiments of the present disclosure can be adopted in a form of a complete hardware embodiment, a complete software embodiment, or an embodiment of a combination of software and hardware. Furthermore, an embodiment of the present disclosure can be adopted in a form of a computer program product implemented by one or more computer usable storage media (which include, but are not limited to a magnetic storage device, CD-ROM, an optical storage device, etc.) including computer usable program codes.

The embodiments of the present disclosure is described with reference to flowcharts and/or block diagrams of the methods, terminal devices (systems), and computer program products according to the embodiments of the present disclosure. It should be understood that computer program instructions may be used to implement each process and/or block in the flowcharts and/or block diagrams and a combination of process(es) and/or block(s) in the flowcharts and/or the block diagrams. These computer program instructions may be provided to a general-purpose computer, a special-purpose computer, an embedded processor, or a processor of another programmable data processing terminal device to generate a machine, so that the instructions executed by a computer or a processor of another programmable data processing terminal device generate an apparatus for implementing function(s) specified in one or more processes in the flowcharts and/or in one or more blocks in the block diagrams.

These computer program instructions may also be stored in a computer readable storage device that can instruct a computer or another programmable data processing terminal device to perform operations in a particular manner, such that the instructions stored in the computer readable storage device generate an article of manufacture that includes an instruction apparatus. The instruction apparatus implements function(s) that is/are specified in one or more processes in the flowcharts and/or in one or more blocks in the block diagrams.

These computer program instructions may also be loaded onto a computer or another programmable data processing terminal device, such that a series of operations are performed on the computer or the other programmable terminal device, thereby generating computer-implemented processing. Therefore, the instructions executed on the computer or the other programmable terminal device provide a procedure for implementing function(s) specified in one or more processes in the flowcharts and/or in one or more blocks in the block diagrams.

Although exemplary embodiments in the embodiments of the present disclosure have been described, one skilled in the art may perform other changes and modifications to these embodiments after knowing the basic inventive concept. Therefore, the appended claims are intended to be interpreted as including the exemplary embodiments and all the changes and modifications that fall into the scope of the embodiments of the present disclosure.

Finally, it should be further noted that relational terms such as “first” and “second” are only used for distinguishing one entity or operation from another entity or operation, and does not necessarily require or imply any of these relationships or ordering between these entities or operations in reality. Moreover, terms such as “include”, “contain” or other variations thereof are intended to cover non-exclusive inclusion, so that a process, method, article or terminal device including a series of elements not only includes the elements, but also includes other elements not explicitly listed, or further includes inherent elements of the process, method, article or terminal device. Without further restrictions, an element defined by a phrase “include a/an . . . ” does not exclude other same elements to exist in a process, method, article, or terminal device that includes the element.

Time series based data prediction methods and time series based data prediction apparatuses provided in the present disclosure are described in detail above. Specific examples are used herein to illustrate the principles and implementations of the present disclosure, and the description of the above embodiments is merely used to help understand the methods of the present disclosure and the core ideas thereof. Furthermore, one of ordinary skill in the art may change the specific implementations and scopes of application based on the ideas of the present disclosure. In short, the content of the specification should not be construed as limitations to the present disclosure.

The present disclosure can further be understood using the following clauses.

Clause 1: A time series based data prediction method, comprising: obtaining historical time series data of a plurality of category objects, the category objects including one or more data objects; selecting feature category object(s) from the plurality of category objects, the feature category object(s) being category object(s) including a respective feature data object, and the respective feature data object being a data object having a life cycle less than a predetermined time threshold; and predicting a target data object from among data object(s) included in the feature category object(s) based on historical time series data corresponding to the feature category object(s), the target data object being a data object with future time series data that is generated in a future first predetermined time period and satisfies a predetermined growth trend.

Clause 2: The method of Clause 1, further comprising predicting the future time series data of the target data object in the future first predetermined time period.

Clause 3: The method of Clause 1 or 2, wherein obtaining the historical time series data of the plurality of category objects comprises: calculating an amount of designated feature data corresponding to the data object that is stored in a predetermined database in each time interval as historical feature data of the data object in the respective time interval, for a plurality of predetermined time intervals; organizing historical feature data of the data object in all the time intervals to obtain historical time series data of the data object; calculating a sum of historical feature data of data objects included in each category object in the respective time interval according to the respective time interval; and organizing respective sums of historical feature data of all the time interval as historical time series data of the respective category object.

Clause 4: The method of Clause 3, wherein selecting feature category object(s) from the plurality of category objects comprises: selecting a first feature category object from the plurality of category objects based on the historical time series data of the plurality of category objects; obtaining a predetermined second feature category object; and organizing the first feature category object and the second feature category object as a feature category object.

Clause 5: The method of Clause 4, wherein selecting the first feature category object from the plurality of category objects based on the historical time series data of the plurality of category objects comprises: calculating a median value M of historical time series data of each category object in a previous first predetermined time period; calculating a number of time intervals in which a sum of historical feature data is greater than a predetermined multiple of M; and determining that the category object is the first feature category object if the number of intervals in which the sum of historical feature data is greater than the predetermined multiple of M is within a predetermined range.

Clause 6: The method of Clause 1 or 2, wherein predicting the target data object from among the data object(s) included in the feature category object(s) based on the historical time series data corresponding to the feature category object(s) comprises: normalizing the feature category object(s) based on the historical time series data corresponding to the feature category object(s); clustering the data object(s) included in the normalized feature category object(s) to obtain class cluster object(s); predicting a target class cluster object from the class cluster object(s); and setting a data object included in the target class cluster object as the target data object.

Clause 7: The method of Clause 6, wherein predicting the target class cluster object from the class cluster object(s) comprises: calculating first average historical time series data of the class cluster object(s) based on historical time series data of data objects in the class cluster object(s) in a previous one month; calculating second average historical time series data of the class cluster object(s) based on historical time series data of data objects in the class cluster object(s) in a previous thirteenth month; calculating third average historical time series data of the class cluster object(s) based on historical time series data of data objects in the class cluster object(s) in a previous twelfth month; predicting future average time series data of the class cluster object(s) in the future first predetermined time period based on the first average historical time series data, the second average historical time series data and the third average historical time series data; calculating a difference between the future average time series data and the first average historical time series data to obtain indicator data of the class cluster object(s); and setting a class cluster object having indicator data greater than a predetermined threshold as the target class cluster object.

Clause 8: The method of Clause 7, wherein predicting the future time series data of the target data object in the future first predetermined time period comprises: normalizing future average time series data of the class cluster object(s) in the future first predetermined time period to obtain a standard average time series data of each data object in the class cluster object(s); and correcting the standard average time series data of each data object to obtain future time series data of the respective data object in the future first predetermined time period.

Clause 9: The method of any one of Clauses 1, 2, 4, 5, 7, or 8, wherein the data object is commodity data, the category objects are commodity categories, the feature category object(s) is/are time-sensitive commodity categor(ies), the life cycle is a time limit of a commodity, and the time series data is a daily sales volume of the commodity.

Clause 10: A time series based data prediction apparatus, comprising: a historical time series data acquisition module used for obtaining historical time series data of a plurality of category objects, the category objects including one or more data objects; a feature category object selection module used for selecting feature category object(s) from the plurality of category objects, the feature category object(s) being category object(s) including a respective feature data object, and the respective feature data object being a data object having a life cycle less than a predetermined time threshold; and a target data object prediction module used for predicting a target data object from among data object(s) included in the feature category object(s) based on historical time series data corresponding to the feature category object(s), the target data object being a data object with future time series data that is generated in a future first predetermined time period and satisfies a predetermined growth trend.

Clause 11: The apparatus of Clause 10, further comprising a future time series data prediction module used for predicting the future time series data of the target data object in the future first predetermined time period.

Clause 12: The apparatus of Clause 10 or 11, wherein the historical time series data acquisition module comprises: a historical feature data computation sub-module used for calculating an amount of designated feature data corresponding to the data object that is stored in a predetermined database in each time interval as historical feature data of the data object in the respective time interval, for a plurality of predetermined time intervals; a historical feature data organization sub-module used for organizing historical feature data of the data object in all the time intervals to obtain historical time series data of the data object;
a historical feature data statistics sub-module used for calculating a sum of historical feature data of data objects included in each category object in the respective time interval according to the respective time interval; and a historical time series data organization sub-module used for organizing respective sums of historical feature data of all the time interval as historical time series data of the respective category object.

Clause 13: The apparatus of Clause 12, wherein the feature category object selection module comprises: a first feature category object selection sub-module used for selecting a first feature category object from the plurality of category objects based on the historical time series data of the plurality of category objects; a second feature category object acquisition sub-module used for obtaining a predetermined second feature category object; and an organization sub-module used for organizing the first feature category object and the second feature category object as a feature category object.

Clause 14: The apparatus of Clause 13, wherein the first feature category object selection sub-module is further used for: calculating a median value M of historical time series data of each category object in a previous first predetermined time period; calculating a number of time intervals in which a sum of historical feature data is greater than a predetermined multiple of M; and determining that the category object is the first feature category object if the number of intervals in which the sum of historical feature data is greater than the predetermined multiple of M is within a predetermined range.

Clause 15: The apparatus of Clause 10 or 11, wherein the target data object prediction module comprises: a normalization sub-module used for normalizing the feature category object(s) based on the historical time series data corresponding to the feature category object(s); a clustering sub-module used for clustering the data object(s) included in the normalized feature category object(s) to obtain class cluster object(s); a prediction sub-module used for predicting a target class cluster object from the class cluster object(s); and a target data object acquisition sub-module used for setting a data object included in the target class cluster object as the target data object.

Clause 16: The apparatus of Clause 15, wherein the prediction sub-module is further used for: calculating first average historical time series data of the class cluster object(s) based on historical time series data of data objects in the class cluster object(s) in a previous one month; calculating second average historical time series data of the class cluster object(s) based on historical time series data of data objects in the class cluster object(s) in a previous thirteenth month; calculating third average historical time series data of the class cluster object(s) based on historical time series data of data objects in the class cluster object(s) in a previous twelfth month; predicting future average time series data of the class cluster object(s) in the future first predetermined time period based on the first average historical time series data, the second average historical time series data and the third average historical time series data; calculating a difference between the future average time series data and the first average historical time series data to obtain indicator data of the class cluster object(s); and setting a class cluster object having indicator data greater than a predetermined threshold as the target class cluster object.

Clause 17: The apparatus of Clause 16, wherein the future time series data prediction module comprises: a standard data acquisition sub-module used for normalizing future average time series data of the class cluster object(s) in the future first predetermined time period to obtain a standard average time series data of each data object in the class cluster object(s); and a correction sub-module used for correcting the standard average time series data of each data object to obtain future time series data of the respective data object in the future first predetermined time period.

Clause 18: The apparatus of any one of Clauses 10, 11, 13, 14, 16 or 17, wherein the data object is commodity data, the category objects are commodity categories, the feature category object(s) is/are time-sensitive commodity categor(ies), the life cycle is a time limit of a commodity, and the time series data is a daily sales volume of the commodity.

What is claimed is:

1. A method implemented by one or more computing devices, the method comprises:
obtaining historical time series data of a plurality of category objects, the category objects including at least one data object;
selecting one or more feature category objects from the plurality of category objects, the one or more feature category objects being one or more category objects including a respective feature data object, and the respective feature data object being a data object having a life cycle less than a predetermined time threshold; and
predicting a target data object from among one or more data objects included in the one or more feature category objects based on historical time series data corresponding to the one or more feature category objects, the target data object being a data object with future time series data that is generated in a future first predetermined time period and satisfies a predetermined growth trend.

2. The method of claim 1, further comprising predicting the future time series data of the target data object in the future first predetermined time period.

3. The method of claim 1, wherein obtaining the historical time series data of the plurality of category objects comprises:
calculating an amount of designated feature data corresponding to the at least one data object that is stored in a predetermined database in each time interval as historical feature data of the at least one data object in the respective time interval, for a plurality of predetermined time intervals;
organizing historical feature data of the at least one data object in all the time intervals to obtain historical time series data of the at least one data object;
calculating a sum of historical feature data of data objects included in each category object in the respective time interval according to the respective time interval; and
organizing respective sums of historical feature data of all the time interval as historical time series data of the respective category object.

4. The method of claim 3, wherein selecting the one or more feature category objects from the plurality of category objects comprises:
selecting a first feature category object from the plurality of category objects based on the historical time series data of the plurality of category objects;
obtaining a predetermined second feature category object; and
organizing the first feature category object and the second feature category object as a feature category object.

5. The method of claim 4, wherein selecting the first feature category object from the plurality of category objects based on the historical time series data of the plurality of category objects comprises:
calculating a median value M of historical time series data of each category object in a previous first predetermined time period;
calculating a number of time intervals in which a sum of historical feature data is greater than a predetermined multiple of M; and
determining that the category object is the first feature category object if the number of intervals in which the sum of historical feature data is greater than the predetermined multiple of M is within a predetermined range.

6. The method of claim 1 wherein predicting the target data object from among the one or more data objects included in the one or more feature category objects based on the historical time series data corresponding to the one or more feature category objects comprises:
normalizing the one or more feature category objects based on the historical time series data corresponding to the one or more feature category objects;
clustering the one or more data objects included in the one or more normalized feature category objects to obtain one or more class cluster objects;
predicting a target class cluster object from the one or more class cluster objects; and
setting a data object included in the target class cluster object as the target data object.

7. The method of claim 6, wherein predicting the target class cluster object from the one or more class cluster objects comprises:
calculating first average historical time series data of the one or more class cluster objects based on historical time series data of data objects in the one or more class cluster objects in a previous one month;
calculating second average historical time series data of the one or more class cluster objects based on historical time series data of data objects in the one or more class cluster objects in a previous thirteenth month;
calculating third average historical time series data of the one or more class cluster objects based on historical time series data of data objects in the one or more class cluster objects in a previous twelfth month;
predicting future average time series data of the one or more class cluster objects in the future first predetermined time period based on the first average historical time series data, the second average historical time series data and the third average historical time series data;
calculating a difference between the future average time series data and the first average historical time series data to obtain indicator data of the one or more class cluster objects; and
setting a class cluster object having indicator data greater than a predetermined threshold as the target class cluster object.

8. The method of claim 7, wherein predicting the future time series data of the target data object in the future first predetermined time period comprises:
normalizing future average time series data of the one or more class cluster objects in the future first predetermined time period to obtain a standard average time series data of each data object in the one or more class cluster objects; and
correcting the standard average time series data of each data object to obtain future time series data of the respective data object in the future first predetermined time period.

9. The method of claim 1, wherein the at least one data object is commodity data, the plurality of category objects are commodity categories, the one or more feature category objects are time-sensitive commodity categories, the life cycle is a time limit of a commodity, and the time series data is a daily sales volume of the commodity.

10. An apparatus comprising:
one or more processors;
memory;
a historical time series data acquisition module stored in the memory and executable by the one or more processors to obtain historical time series data of a plurality of category objects, the category objects including one or more data objects;
a feature category object selection module stored in the memory and executable by the one or more processors to select feature category object(s) from the plurality of category objects, the feature category object(s) being category object(s) including a respective feature data object, and the respective feature data object being a data object having a life cycle less than a predetermined time threshold; and
a target data object prediction module stored in the memory and executable by the one or more processors to predict a target data object from among data object(s) included in the feature category object(s) based on historical time series data corresponding to the feature category object(s), the target data object being a data object with future time series data that is generated in a future first predetermined time period and satisfies a predetermined growth trend.

11. The apparatus of claim 10, further comprising a future time series data prediction module used for predicting the future time series data of the target data object in the future first predetermined time period.

12. The apparatus of claim 10, wherein the historical time series data acquisition module comprises:
a historical feature data computation sub-module used for calculating an amount of designated feature data corresponding to the at least one data object that is stored in a predetermined database in each time interval as historical feature data of the at least one data object in the respective time interval, for a plurality of predetermined time intervals;
a historical feature data organization sub-module used for organizing historical feature data of the at least one data object in all the time intervals to obtain historical time series data of the at least one data object;
a historical feature data statistics sub-module used for calculating a sum of historical feature data of data objects included in each category object in the respective time interval according to the respective time interval; and
a historical time series data organization sub-module used for organizing respective sums of historical feature data of all the time interval as historical time series data of the respective category object.

13. The apparatus of claim 12, wherein the feature category object selection module comprises:
a first feature category object selection sub-module used for selecting a first feature category object from the plurality of category objects based on the historical time series data of the plurality of category objects;
a second feature category object acquisition sub-module used for obtaining a predetermined second feature category object; and
an organization sub-module used for organizing the first feature category object and the second feature category object as a feature category object.

14. The apparatus of claim 13, wherein the first feature category object selection sub-module is further used for:
calculating a median value M of historical time series data of each category object in a previous first predetermined time period;
calculating a number of time intervals in which a sum of historical feature data is greater than a predetermined multiple of M; and
determining that the category object is the first feature category object if the number of intervals in which the sum of historical feature data is greater than the predetermined multiple of M is within a predetermined range.

15. The apparatus of claim 10, wherein the target data object prediction module comprises:
a normalization sub-module used for normalizing the one or more feature category objects based on the historical time series data corresponding to the one or more feature category objects;
a clustering sub-module used for clustering the one or more data objects included in the one or more normalized feature category objects to obtain one or more class cluster objects;
a prediction sub-module used for predicting a target class cluster object from the one or more class cluster objects; and
a target data object acquisition sub-module used for setting a data object included in the target class cluster object as the target data object.

16. The apparatus of claim 15, wherein the prediction sub-module is further used for:
calculating first average historical time series data of the one or more class cluster objects based on historical time series data of data objects in the one or more class cluster objects in a previous one month;
calculating second average historical time series data of the one or more class cluster objects based on historical time series data of data objects in the one or more class cluster objects in a previous thirteenth month;
calculating third average historical time series data of the one or more class cluster objects based on historical time series data of data objects in the one or more class cluster objects in a previous twelfth month;
predicting future average time series data of the one or more class cluster objects in the future first predetermined time period based on the first average historical time series data, the second average historical time series data and the third average historical time series data;
calculating a difference between the future average time series data and the first average historical time series data to obtain indicator data of the one or more class cluster objects; and
setting a class cluster object having indicator data greater than a predetermined threshold as the target class cluster object.

17. The apparatus of claim 16, wherein the future time series data prediction module comprises:
a standard data acquisition sub-module used for normalizing future average time series data of the one or more class cluster objects in the future first predetermined time period to obtain a standard average time series data of each data object in the one or more class cluster objects; and
a correction sub-module used for correcting the standard average time series data of each data object to obtain future time series data of the respective data object in the future first predetermined time period.

18. One or more computer readable media storing executable instructions that, when executed by one or more processors, cause the one or more processors to perform acts comprising:
obtaining historical time series data of a plurality of category objects, the category objects including at least one data object;
selecting one or more feature category objects from the plurality of category objects, the one or more feature category objects being one or more category objects including a respective feature data object, and the respective feature data object being a data object having a life cycle less than a predetermined time threshold; and
predicting a target data object from among one or more data objects included in the one or more feature category objects based on historical time series data corresponding to the one or more feature category objects, the target data object being a data object with future time series data that is generated in a future first predetermined time period and satisfies a predetermined growth trend.

19. The one or more computer readable media of claim 18, wherein obtaining the historical time series data of the plurality of category objects comprises:
calculating an amount of designated feature data corresponding to the at least one data object that is stored in a predetermined database in each time interval as historical feature data of the at least one data object in the respective time interval, for a plurality of predetermined time intervals;
organizing historical feature data of the at least one data object in all the time intervals to obtain historical time series data of the at least one data object;
calculating a sum of historical feature data of data objects included in each category object in the respective time interval according to the respective time interval; and
organizing respective sums of historical feature data of all the time interval as historical time series data of the respective category object.

20. The one or more computer readable media of claim 18, wherein selecting the one or more feature category objects from the plurality of category objects comprises:
selecting a first feature category object from the plurality of category objects based on the historical time series data of the plurality of category objects;
obtaining a predetermined second feature category object; and
organizing the first feature category object and the second feature category object as a feature category object.
